(19) United States
(12) Patent Application Publication
(10) Pub. No.: US 2013/0091053 A1
(43) Pub. Date: Apr. 11, 2013

(54) APPARATUS FOR PROVIDING SERVICE LINKING CLOSED USER GROUPS BASED ON SMART TELEVISION AND SMART SET-TOP BOX

(71) Applicants: Heung Soo Park, Namyangju-si (KR); Tae Suk Oh, Seoul (KR)

(72) Inventors: Heung Soo Park, Namyangju-si (KR); Tae Suk Oh, Seoul (KR)

(73) Assignee: HANHWA SOLUTION & CONSULTING CO., LTD, Seoul (KR)

(21) Appl. No.: 13/287,159

(22) Filed: Nov. 2, 2011

(30) Foreign Application Priority Data
Oct. 10, 2011 (KR) 10-2011-0102904

(51) Int. Cl. G06F 15/16; G06Q 20/38

(52) U.S. Cl. 705/39; 709/217; 709/203

(57) ABSTRACT

Provided is an apparatus for providing a service that links closed user groups (CUGs) based on a smart TV and a smart set-top box. A server may provide at least one application (app) store: The app store may register apps provided by developers, and may provide the registered apps to users of a CUG. The app retriever may provide a result of inquiry and retrieval performed with respect to apps registered in the at least one app store, to a terminal that performs the inquiry and retrieval. The terminal distributed for a predetermined CUG service may use apps associated with varied CUG services through the server.

### CROSS-REFERENCE TO RELATED APPLICATION

This application claims the benefit of Korean Patent Application No. 10-2011-0102904, filed on Oct. 10, 2011, in the Korean Intellectual Property Office, the disclosure of which is incorporated herein by reference.

### BACKGROUND OF THE INVENTION

The present invention relates to an apparatus for providing a service linking closed user groups, and particularly, to a system that provides a service linking a plurality of closed user groups based on a smart TV and a smart set-top box.

A closed user group (CUG) service may refer to a service provided restrictively to a predetermined organization or predetermined users. Examples of the CUG may include a group of users associated with a health care service, a group of users associated with a predetermined hospital, a group of users of a predetermined bank, a group of members in a predetermined local government, and the like.

In general, a CUG service based on an internet protocol television (IPTV) or a cable TV may be provided by a network provider. The IPTV or the cable TV service may be provided based on a closed structure in terms of a profit structure, a service change, and the like.

For a service requester, that is, an operator of the CUG service, it is difficult to develop, edit, and change a unique content associated with a predetermined CUG service. For a service provider, that is, a provider of a network to which a CUG service is provided, there is no way to make an additional profit except for a profit obtained by charging based on a channel allocation ratio and a profit obtained by producing a content, and attracting a new customer is difficult.

Korean patent No. 10-2009-0084004, published on Aug. 5, 2009, discloses a broadcasting service system using an internet protocol. The broadcasting service system may integrate and manage members in a group to which a private broadcasting content is provided based on an IPTV service through a CUG service, and may enable linkable contents in all CUG groups to be shared.

### SUMMARY OF THE INVENTION

An aspect of the present invention provides a server that provides an open-type service that links varied CUGs which are based on a smart TV and a smart set-top box.

Another aspect of the present invention also provides a server that performs cross-selling of an app connected to a different CUG service through an open-type service.

According to an aspect of the present invention, there is provided a server, including at least one application (app) store to register apps provided by developers, and to provide the registered apps to users, an app provided by each app store being used for a corresponding closed user group (CUG) service among at least one CUG service, an app retriever to provide, a terminal, a result of inquiry and/or retrieval performed with respect to an app, and an app provider to provide an app selected by the terminal through the inquiry and/or retrieval.

The server may include the terminal provided for a predetermined CUG service among the at least one CUF service, and the application retriever may provide a result of inquiry and/or retrieval performed with respect to the apps registered in the at least one app store.

The app may include a widget, and the widget may be registered in the terminal, may be displayed on an output screen of the terminal, and may enable a user to access the app.

The server may further include a writing tool distributor to distribute a writing tool to develop apps to be registered in the at least one app store, and the writing tool may provide a user interface (UI) that enables apps registered in different stores among the at least one app store to be displayed in a consistent form at the terminal.

The server may further include a charging unit to charge a user of the terminal for the app provided to the terminal, and to pay a provider of a CUG service corresponding to an app store of the app provided to the terminal, all or a portion of the charge.

Additional aspects, features, and/or advantages of the invention will be set forth in part in the description which follows and, in part, will be apparent from the description, or may be learned by practice of the invention.

### EFFECT

According to embodiments of the present invention, a server may provide an open-type service that links varied CUGs which are based on a smart TV and a smart set-top box.

According to embodiments of the present invention, a server may perform cross-selling of an app connected to a different CUG service through an open-type service.

According to embodiments of the present invention, a server may provide a service model that obtains an additional profit through the cross-selling.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a closed user group (CUG) service domain according to an embodiment of the present invention;

FIG. 2 is a diagram illustrating a system that provides a service linking CUGs according to an embodiment of the present invention; and

FIG. 3 is a diagram illustrating a widget according to an embodiment of the present invention.

FIG. 4 is a diagram illustrating a configuration of a server according to an embodiment of the present invention.

### DETAILED DESCRIPTION OF THE INVENTION

Reference will now be made in detail to embodiments of the present invention, examples of which are illustrated in the accompanying drawings, wherein like reference numerals refer to the like elements throughout. Embodiments are described below to explain the present invention by referring to the figures.

An application may indicate a program operating in a predetermined platform. Also, the application may indicate a program for a predetermined platform distributed by an application store. The application may be referred to as an app.

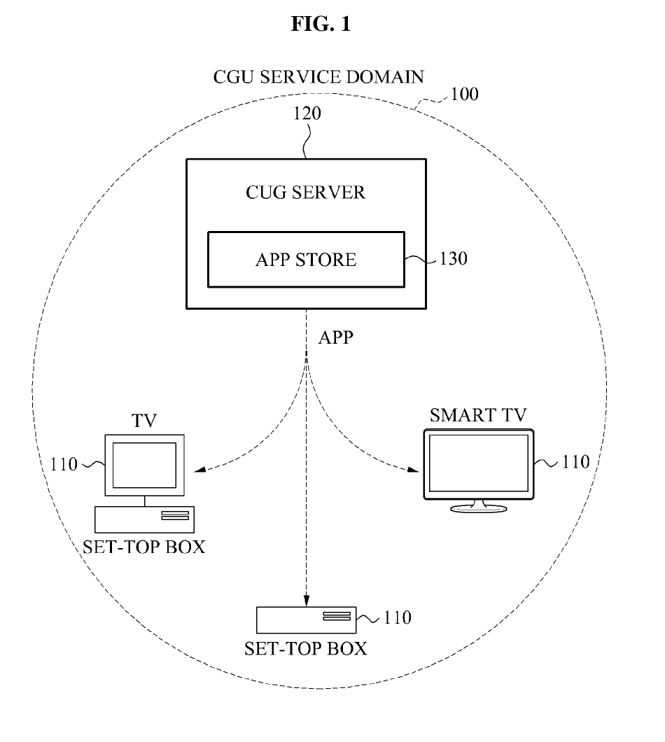

FIG. 1 illustrates a closed user group (CUG) service domain according to an embodiment of the present invention.

The CUG service domain 100 may include a CUG server 120 and at least one terminal 110.

The at least one terminal 110 may be a set-top box or a smart TV that may perform inquiry, retrieval, registration, and execution with respect to an app. When the terminal 110 is the set-top box, the terminal 110 may include a TV along with the set-top box. The at least one terminal 110 may have the same hardware and the same platform. The platform may be an open platform. Therefore, varied service users may use the platform, and varied developers may join developing an application (app) of the at least one terminal 110.

The CUG server 120 may include an app store 130. The app store 130 may register apps to be used for a CUG service. Here, the apps may be provided by developers. The app store 130 may provide the registered apps to users of the CUG service.

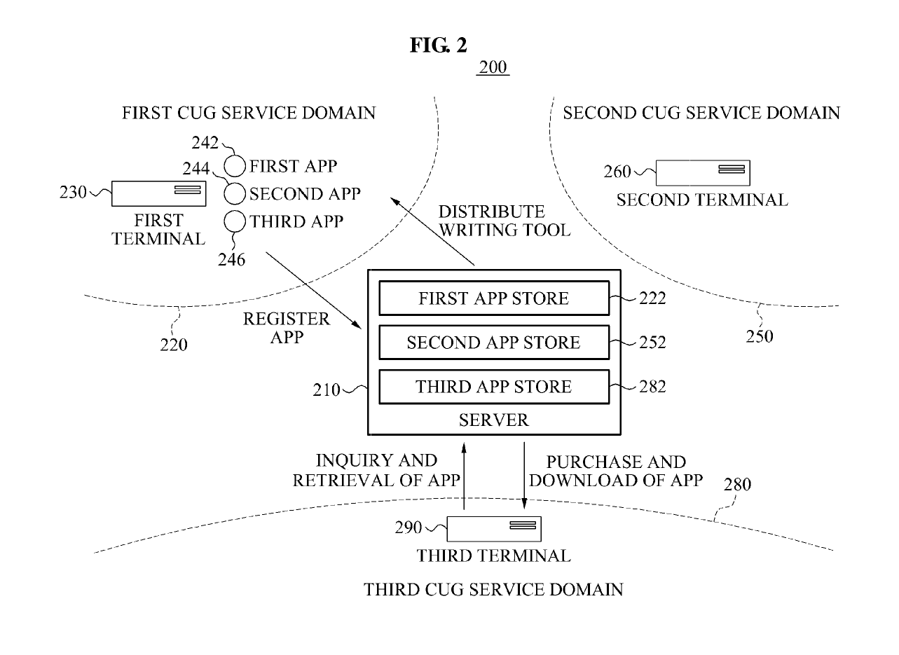

FIG. 2 illustrates a system 200 that provides a service linking CUGs according to an embodiment of the present invention.

Referring to FIG. 2, the system 200 may include a first CUG service domain 220, a second CUG service domain 250, and a third CUG service domain 280. Each service domain may be a domain for providing a predetermined CUG service. For example, a first CUG service provided by the first CUG service domain 220 may be an education service, a second CUG service provided by the second CUG service domain 250 may be a health care service, and a third CUG service provided by the third CUG service domain 280 may be a local service.

Each CUG service domain may include the at least one terminal 110. In this instance, a terminal may be used for a predetermined CUG service among at least one CUG service. For example, a first terminal 230 may be a terminal produced, sold, and/or lent by a first CUG service provider for the first CUG service. The first terminal 230 may be a terminal for education, a second terminal 260 may be a terminal for healthcare, and a third terminal 290 may be a terminal for a service provided within an apartment complex.

Each CUG service provider may distribute the terminal 230, 260, or 290 to be used for a CUG service, to a group, that is, users, provided with a CUG service. The terminals 230, 260, and 290 distributed to the CUG service domains 220, 250, and 280, respectively, may have the same hardware and the same platform. Here, the platform may be an open platform. Therefore, CUG service providers may use the platform and developers may join developing apps of the terminals 230, 260, and 290.

Each terminal, for example, the terminals 230, 260, and 290, may register and execute varied apps provided by a CUG service in which a corresponding terminal is included. In this example, varied apps may be included in the terminal.

The server 210 may provide app stores 222, 252, and 282 of the CUG service domains 220, 250, and 280. A user of the first terminal 230 may purchase and/or download varied desired apps from the first app store 222 that provides an education app of the first CUG service. In this example, the first app store 222 may authenticate a user of the first terminal 230, and may provide the app to the first terminal 230 with and/or without fee.

When a first app 242, a second app 244, and a third app 246 are registered in the app store 222, the first terminal 230 may download all or a portion of the apps 242, 244, and 246 from the first app store 222 and install the downloaded app.

The server 210 may support cross-selling between CUG service domains. As an example, when a predetermined user of the third CUG service using the third terminal 290 desires to use an educational app of the first CUG service, the third terminal 290 may perform inquiry and/or retrieval with respect to an education app of the first CUG service through the server 210. The third terminal 290 may purchase and/or download an app from the first app store 222 that provides an app of the first CUG service. The first app store 222 may authenticate the user of the third terminal 290, and may provide the app to the third terminal 290 with and/or without fee.

When the open platform based on a smart TV or a set-top box is sold and distributed to users of CUGs, for example, a predetermined local government, a predetermined hospital, a predetermined apartment complex, a predetermined bank, a predetermined insurance company, a predetermined fitness club, and the like, a number of services and applications for each domain may increase gradually. Users in each domain may use a desired app among apps in other domains through the cross-selling. A service operator and an app developer in each domain may gain an additional profit by cross-selling an app to a user in a different domain.

The operator who owns and/or manages the server 210 may provide a writing tool to a provider and/or a developer of each CUG service so that the provider and/or developer may develop an app of a corresponding CUG service. The provider and/or developer of each CUG service may develop an app of a corresponding CUG service, for example, the first app 242, the second app 244, and the third app 246, and may register the app in an app store of the service 210.

The operator of the server 210 may distribute a user interface (UI) and/or a graphic user interface (GUI) guideline along with the writing tool, so that apps may be displayed in a consistent form at the terminals 230, 260, and 290.

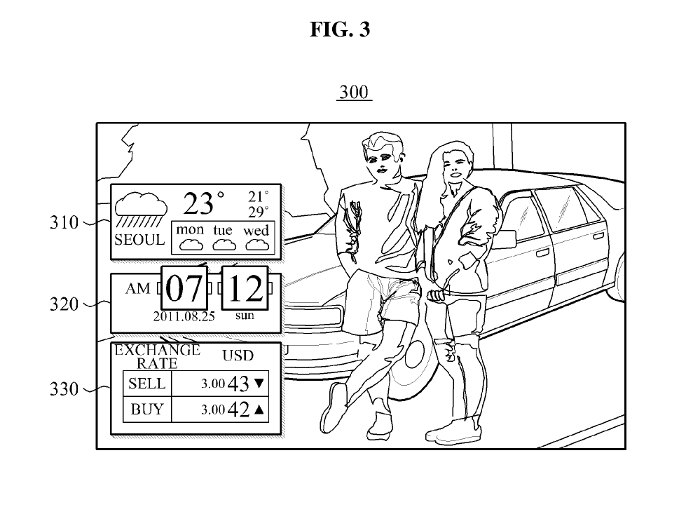

FIG. 3 illustrates a widget according to an embodiment of the present invention.

The widget may indicate an object displayed on an output screen of a terminal. Referring to FIG. 3, three widgets, that is, a first widget 310, a second widget 320, and a third widget 330, may be displayed on an output screen 300 of the terminal.

As an example, an app may include a widget. In this example, when an app is registered in a terminal, the terminal may display a widget associated with the registered app on an output screen. The widget displayed on the output screen may provide an access to the app. Downloading and registering of an app by the terminal may be regarded as installing of a widget on an output screen. Therefore, the server 210 may be a widget launcher server.

The widgets 310, 320, and 330 on the output screen 300 may be widgets associated with apps of different CUG service domains. For example, the first widget 310 may be a widget associated with an app of a first CUG service domain provided by the first app store 222, and the third widget 330 may be a widget associated with an app of a third CUG service domain provided by the third app store 282. That is, although a terminal is distributed by a predetermined CUG service domain, for example, the first terminal 230, the terminal may use varied apps provided by varied CUG service domains.

The service 210 may support selection of a widget and execution of a widget. For example, the terminal may select one of a plurality of widgets provided by the server 210, and the sever 210 may execute the selected widget and thus, the selected widget may be installed and/or executed in the terminal.

Based on a UI and/or a GUI guideline, the widgets 310, 320, and 330 may be displayed in a consistent form. Therefore, a writing tool may restrict and/or induce that various CUG services are expressed in a consistent form.

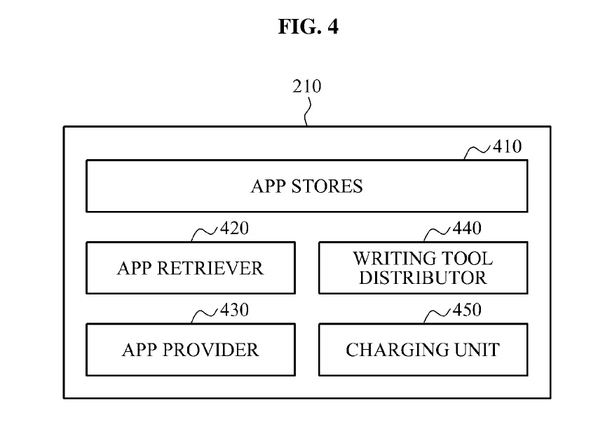

FIG. 4 illustrates a configuration of a server according to an embodiment of the present invention.

The server 210 may include at least one app store 410, an app retriever 420, an app provider 430, a writing tool distributor 440, and a charging unit 450.

The at least one app store 410 may register apps provided by a corresponding developer, and may provide the registered app to users. For example, the at least one app store 410 may provide an app to be used for a corresponding CUG service among at least one CUG service.

The app retriever 420 may provide a result of an inquiry and/or retrieval performed with respect to the apps registered in the at least one app store 410.

The terminal may be provided for a predetermined CUG service among the at least one CUG service, for example, the first terminal 230, the second terminal 260, and the third terminal 290 as illustrated in FIG. 2. The app retriever 420 may provide a result of an inquiry and/or retrieval with respect to all apps registered in the at least one app store 410.

The app provider 430 may provide an app selected by a terminal through the inquiry and/or retrieval, to the terminal. The app provided by the app provider may include a widget. The widget may be registered in the terminal and thus, may be displayed on an output screen of the terminal, and may enable a user of the terminal to access the app.

The writing tool distributor 440 may distribute a writing tool to develop apps to be registered in the at least one app store 410.

The writing tool may provide a UI that enables apps registered in different stores among the at least one app store 410 to be displayed in a consistent form at the terminal.

The charging unit 450 may charge the user of the terminal for the app provided to the terminal, and may pay a provider of a CUG service corresponding to an app store of the app provided to the terminal, all or a portion of the charge.

Exemplary embodiments described with reference to FIGS. 1 through 3 may be applicable to the present embodiment and thus, detailed descriptions thereof will be omitted for conciseness.

Conventionally, an IPTV provider or a cable TV provider that provides a CUG service using a closed network may have difficulty in obtaining an additional profit except for a profit gained by lending a channel, due to a characteristic of a CUG service merely provided to limited number of users.

According to exemplary embodiments of the present invention, an open platform may be distributed to a plurality of predetermined users, unlike a conventional IPTV and cable TV which provide services to a plurality of uncertain users. Therefore, the IPTV provider or the cable TV provider may gain an additional profit by cross-selling an app to the plurality of predetermined users.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A server, comprising:
at least one application (app) store to register apps provided by developers, and to provide the registered apps to users, an app provided by each app store being used for a corresponding closed user group (CUG) service among at least one CUG service;
an app retriever to provide, a terminal, a result of inquiry and/or retrieval performed with respect to an app; and
an app provider to provide an app selected by the terminal through the inquiry and/or retrieval.

2. The server of claim 1, wherein:
the terminal is provided for a predetermined CUG service among the at least one CUF service; and
the application retriever provides a result of inquiry and/or retrieval performed with respect to the apps registered in the at least one app store.

3. The server of claim 1, wherein:
the app comprises a widget, and
the widget is registered in the terminal, is displayed on an output screen of the terminal, and enables a user to access the app.

4. The server of claim 1, further comprising:
a writing tool distributor to distribute a writing tool to develop apps to be registered in the at least one app store,
wherein the writing tool provides a user interface (UI) that enables apps registered in different stores among the at least one app store to be displayed in a consistent form at the terminal.

5. The server of claim 1, further comprising:
a charging unit to charge a user of the terminal for the app provided to the terminal, and to pay a provider of a CUG service corresponding, to an app store of the app provided to the terminal, all or a portion of the charge.
